(19) United States
(12) Patent Application Publication
(10) Pub. No.: US 2025/0277972 A1
(43) Pub. Date: Sep. 4, 2025

(54) OPTICAL SEGMENTATION ELEMENT AND OPTICAL SYSTEM FOR A VIRTUAL RETINAL SCAN DISPLAY

(71) Applicant: Robert Bosch GmbH, Stuttgart (DE)

(72) Inventors: Johannes Meyer, Haseluenne (DE); Johannes Fischer, Pliezhausen (DE); Thomas Alexander Schlebusch, Renningen (DE)

(21) Appl. No.: 18/859,044

(22) PCT Filed: Jun. 12, 2023
(86) PCT No.: PCT/EP2023/065589

§ 371 Date: Oct. 22, 2024

(30) Foreign Application Priority Data
Aug. 23, 2022 (DE) 10 2022 208 721.6

(51) Int. Cl. G02B 27/00; G02B 26/10; G02B 27/01

(52) U.S. Cl. CPC G02B 27/0093; G02B 26/101; G02B 27/0172; G02B 2027/0178

(57) ABSTRACT

An optical segmentation element. The optical segmentation element includes at least a first segment for projecting an image content generated using a scanning projector unit via a first imaging path onto at least one projection region of a diverting unit. The optical segmentation element further includes a second segment for projecting the image content generated using the scanning projector unit via a second imaging path that is different from the first onto the at least one projection region of the diverting unit. The first or second segment of the optical segmentation element are covered at least partly with a covering that reflects or absorbs light beams in an infrared wavelength range.

### FIELD

The present invention relates to an optical segmentation element, an optical system for a virtual retinal scan display and a method for producing an optical segmentation element.

### BACKGROUND INFORMATION

A segmentation lens used for infrared eye tracking is described in U.S. Patent No. 11,093,034 B2.

An object of the present invention is to develop an optical segmentation element comprising at least two segments, which improves the eye tracking of the user of a virtual retinal scan display.

### SUMMARY

To achieve the object, an optical segmentation element having certain features of the present invention is provided. An optical system for a virtual retinal scan display and a method for producing an optical segmentation element are provided according to the present invention as well.

The optical segmentation element is in particular configured for use in an optical system for a virtual retinal scan display. According to an example embodiment of the present invention, the optical segmentation element comprises at least a first segment for projecting an image content generated by means of a scanning projector unit via a first imaging path onto at least one projection region of a diverting unit. The scanning projector unit and the diverting unit are in particular part of the optical system for the virtual retinal scan display. The optical segmentation element also comprises a second segment for projecting the image content generated by means of the scanning projector unit via a second imaging path that is different from the first onto the at least one projection region of the diverting unit. The first segment of the optical segmentation element is covered, in particular coated, at least partly with a covering that reflects or absorbs light beams in an infrared wavelength range. Alternatively, the second segment of the optical segmentation element is covered, in particular coated, at least partly with the covering that reflects or absorbs light beams in the infrared wavelength range. This prevents crosstalk between infrared light beams that reach the diverting unit via the first imaging path of the first segment and the second imaging path of the second segment. Crosstalk describes the state in which light hits the same eye region via more than one imaging path, resulting in image artifacts during image reconstruction.

According to an example embodiment of the present invention, the optical segmentation element preferably also comprises a third segment for projecting the image content generated by means of the scanning projector unit via a third imaging path that is different from the first and second onto the at least one projection region of the diverting unit. The optical segmentation element moreover comprises a fourth segment for projecting the image content generated by means of the scanning projector unit via a fourth imaging path that is different from the first, second and third onto the at least one projection region of the diverting unit.

Such a segmentation element with four segments enables an enlarged effective eyebox for the user of the virtual retinal scan display, because using the four segments and the diverting unit makes it possible to produce four different eyeboxes, in particular at a defined distance from one another. Preferably, at least three segments are covered, in particular coated, at least partly with the covering that reflects or absorbs light beams in the infrared wavelength range. In particular, exactly three segments are covered at least partly with the covering that reflects or absorbs light beams in the infrared wavelength range. In this case, too, crosstalk between infrared light beams that reach the diverting unit via at least two different imaging paths is prevented. Alternatively, two segments, in particular exactly two segments, are covered or coated at least partly with the covering that reflects or absorbs light beams in the infrared wavelength range. In this case, eye tracking from two different perspectives is made possible.

According to an example embodiment of the present invention, the optical segmentation element is preferably configured as an optical segmentation lens.

According to an example embodiment of the present invention, the reflective or absorbent covering is preferably configured to reflect or absorb light beams in a wavelength range between 800 nm and 1550 nm. This wavelength range includes infrared light, which is invisible to the human eye and is therefore particularly suitable for eye tracking.

According to an example embodiment of the present invention, the covering is preferably configured as a coating. Alternatively, the covering is configured as a foil. Another alternative is that the covering is configured as a film.

According to an example embodiment of the present invention, the covering is preferably made of BK7 (borosilicate crown glass). The covering is alternatively made of silicon. Another alternative is that the covering is made of germanium.

A further subject matter of the present invention is an optical system for a virtual retinal scan display which comprises an image source that provides the image content in the form of image data. According to an example embodiment of the present invention, the optical system also comprises an image processing device for the image data and the above-described optical segmentation element. The optical system further comprises a projector unit with a time-modulatable first light source for generating at least one first light beam and a controllable deflecting device for the at least one first light beam for scanning projection of the image content onto the optical segmentation element. The projector unit compromises a second light source for generating at least one second light beam in an infrared wavelength range. The first controllable deflecting device here is configured to scanningly deflect the at least one second light beam onto the optical segmentation element. The optical system also comprises a diverting unit onto which the image content from the optical segmentation element can be projected and which is configured to direct the projected image content onto an eye of a user. The diverting unit is further configured to, in particular scanningly, direct the second light beam arriving, in particular radiating in, from the optical segmentation element via a first or second imaging path onto the eye of the user. The optical segmentation element also comprises a first sensor which is configured to acquire second light beams backscattered by the pupil or a modulation of a power, in particular a laser power, of the second light source. The optical system therefore not only enables a display of virtual images for the user of the virtual retinal scan display, but also eye tracking of at least one eye of the user. The virtual images can thus in particular be generated as a function of a detected state of the eye of the user.

According to an example embodiment of the present invention, the projector unit is preferably configured to combine the first and second light beams to a common light beam. The first and second light beam are thus scanned along the same scan path along the optical segmentation element by means of the controllable deflecting device.

The first sensor is preferably configured as a part, in particular as a second photodetector, of a laser feedback interferometer. The laser feedback interferometer is in particular integrated into the projector unit. The first sensor is alternatively configured as an, in particular an external, first photodetector. The first photodetector is in particular disposed on a frame of a pair of smart glasses as an optical system. Alternatively, the first photodetector is disposed in the light path of the second light beam. A beam splitter, which diverts a part of the second light beam in the direction of the first photodetector, is then in particular provided as well.

According to an example embodiment of the present invention, The optical system preferably also comprises a computing unit which is configured to create a first image of a first eye region with the pupil of the user from the acquired backscattered second light beams or the acquired modulation of the power of the second light source. The computing unit is moreover preferably configured to ascertain an eye position as a function of the created first image of the first eye region. The computing unit is preferably further configured to ascertain a gaze vector of the user as a function of the created first image. The optical segmentation element preferably comprises four segments for projecting the image content via four different imaging paths onto at least one projection region of the diverting unit. One segment is assigned to each imaging path. Two segments, in particular exactly two segments, are covered at least partly with a covering that reflects or absorbs light beams in the infrared wavelength range. The optical segmentation element is configured to divert the second light beams in the two segments which are free of the reflective or absorbent covering along the respective imaging path onto the projection region of the diverting unit. The diverting unit is further configured to, in particular scanningly, direct the second light beams onto the eye of the user. The computing unit here serves to create a second image of the first eye region with the pupil of the user from the acquired backscattered second light beams or the acquired modulation of the power of the second light source. The first and second image and thus the generation of a type of stereo image can be used to ascertain a gaze vector of the user in a particularly robust manner by means of the computing unit. The diverting unit is preferably configured as a first holographic optical element, which, due to the angular offset of the second light beams radiating in via the two different imaging paths, diverts the second light beams at different angles onto the first eye region of the pupil of the user. Alternatively, the optical system comprises another third light source for generating at least one third light beam in an infrared wavelength range. The wavelength of the second and third light beams differ from one another. The diverting unit is made here of a second and third holographic optical element. The second holographic optical element serves to divert the second light beams onto the eye of the user and the third holographic optical element serves to divert the third light beams onto the eye of the user. The optical system then preferably comprises a further second sensor, which is configured to acquire third light beams backscattered by the pupil or a modulation of a power, in particular a laser power, of the third light source. In both cases, the first and second image depict the same eye region of the user but taken from different perspectives.

According to an example embodiment of the present invention, the optical system for a virtual retinal scan display is preferably configured as smart glasses.

A further subject matter of the present invention is a method for producing an optical segmentation element. The method is in particular used to produce the above-described optical segmentation element of the present invention. According to an example embodiment of the present invention, first, an optical segmentation element, in particular for use in an optical system for a virtual retinal scan display, is provided. The optical segmentation element comprises at least a first and a second segment. In a further method step, a covering that reflects or absorbs light beams in an infrared wavelength range is created on the first or second segment, in particular an outer surface of the first or second segment, of the optical segmentation element. The covering is in particular applied to the first or second segment as a coating by means of powder coating, spraying or painting. Alternatively, the first and second segment are coated completely first and then the first or second segment is freed using a laser.

### BRIEF DESCRIPTION OF THE DRAWINGS

FIG. 1 shows a first embodiment of an optical system for a virtual retinal scan display, according to the present invention.

FIG. 2 shows an optical segmentation element for use in an optical system for a virtual retinal scan display, according to an example embodiment of the present invention.

FIG. 3 shows a second embodiment of an optical system for a virtual retinal scan display, according the present invention.

FIG. 4 shows a first embodiment of a method for producing an optical segmentation element, according to the present invention.

FIG. 5 shows a second embodiment of a method for producing an optical segmentation element, according to the present invention.

### DETAILED DESCRIPTION OF EXAMPLE EMBODIMENTS

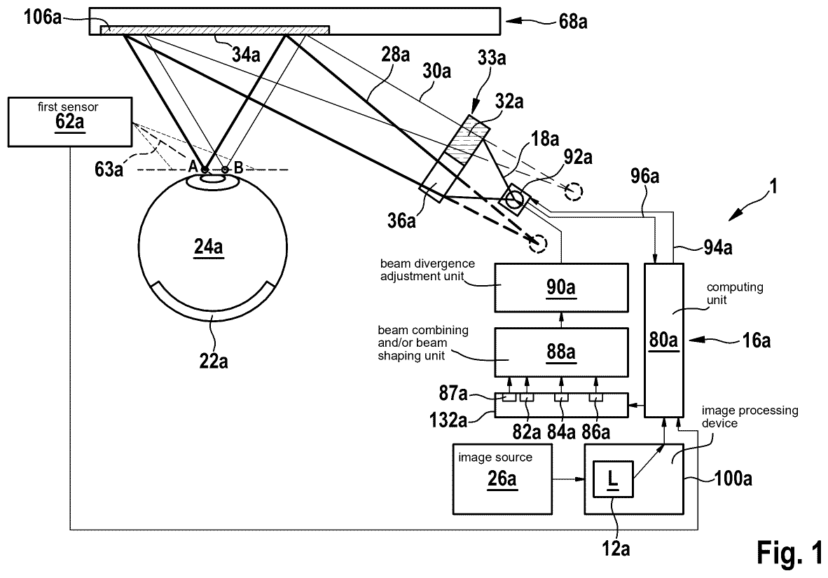

FIG. 1 schematically shows a first embodiment of an optical system 1 for a virtual retinal scan display which comprises an image source 26a that provides the image content in the form of image data 12a. The optical system 1 also comprises an image processing device 100a for the image data 12a. The optical system 1 a further comprises a projector unit 16a with a time-modulatable first light source 82a for generating at least one first light beam and a controllable deflecting device 92a for the at least one first light beam for scanning projection of the image content onto the optical segmentation element 33a of the optical system 1. The projector unit 15a also compromises a second light source 87a for generating at least one second light beam in an infrared wavelength range. The controllable deflecting device 92a serves to scanningly deflect the at least one second light beam onto the optical segmentation element 33a. The optical system 1 also includes the above-mentioned optical segmentation element 33a, which comprises a first segment 32a for projecting the image content generated by means of the scanning projector unit 16a via a first imaging path 30a onto a projection region 34a of a diverting unit 68a of the optical system 1. In this embodiment example, the diverting unit 68a is integrated into a spectacle lens 106a. The optical segmentation element 33a further comprises a second segment 36a for projecting the image content generated by means of the scanning projector unit 16a via a second imaging path 28a that is different from the first onto the projection region 34a of the diverting unit 68a. In this embodiment, the first segment 32a of the optical segmentation element 33a is completely covered with a covering 25a that absorbs light beams in an infrared wavelength range. The second light beams can therefore not pass through the first segment 32a of the optical segmentation element. In this embodiment, the covering 25a is configured as a foil or film made of silicon. The covering 25a serves to absorb light beams in a wavelength range between 800 nm and 1550 nm. The optical system 1 also comprises a diverting unit 68a onto which the image content from the optical segmentation element 33a is projected and which is configured to direct the projected image content onto an eye 24a, in particular a retina 22a, of a user. The diverting unit 68a is moreover configured to direct the second light beam arriving from the optical segmentation element 33a via the second imaging path 28a onto the eye 24a, in particular the retina 22a, of the user. The diverting unit 68a is configured here as a first holographic optical element. The optical system 1 further comprises a first sensor 62a which is configured to acquire second light beams 63a backscattered by the pupil. In this embodiment, the first sensor 62a is configured as an external photodetector, which is mounted on a frame of a pair of smart glasses not shown here as an optical system 1.

In this embodiment of the optical system 1, the projector unit 16a is configured to combine the first and second light beam to a common light beam 18a by means of a beam combining and/or beam shaping unit 88a. The projector unit 16a further includes a beam divergence adjustment unit 90a. The beam divergence adjustment unit 90a is provided to adjust a beam divergence of the common light beam 18a, in particular a laser beam, leaving the projector unit 16; preferably to a path length of the respective currently emitted common light beam 18a which is in particular a function of an arrangement of optical elements of the optical system 68a.

The optical system 1 or the projector unit 16a also comprises a computing unit 80a, which is configured to create a first image of a first eye region with the pupil of the user from the acquired backscattered second light beams 63a. The computing unit 80a is then configured to ascertain an eye state, in particular an eye position, of the user of the virtual retinal scan display, as a function of the first image. The computing unit 80a is further configured to generate first control signals 94a for the controllable deflecting device 92a of the optical system 1 such that the scanning region of the deflecting device 92a is adjusted as a function of the acquired and/or determined first eye state of the user. The controllable deflecting device 92a sends its current position signals back to the projector control unit 80a at regular intervals (see arrow 96a).

The projector unit 16a further comprises a time-modulatable fourth light source 84a for generating a fourth light beam and a time-modulatable fifth light source 86a for generating a fifth light beam. The first light beam provides light in the red wavelength range, the fourth light beam provides light in the green wavelength range, and the fifth light beam provides light in the blue wavelength range.

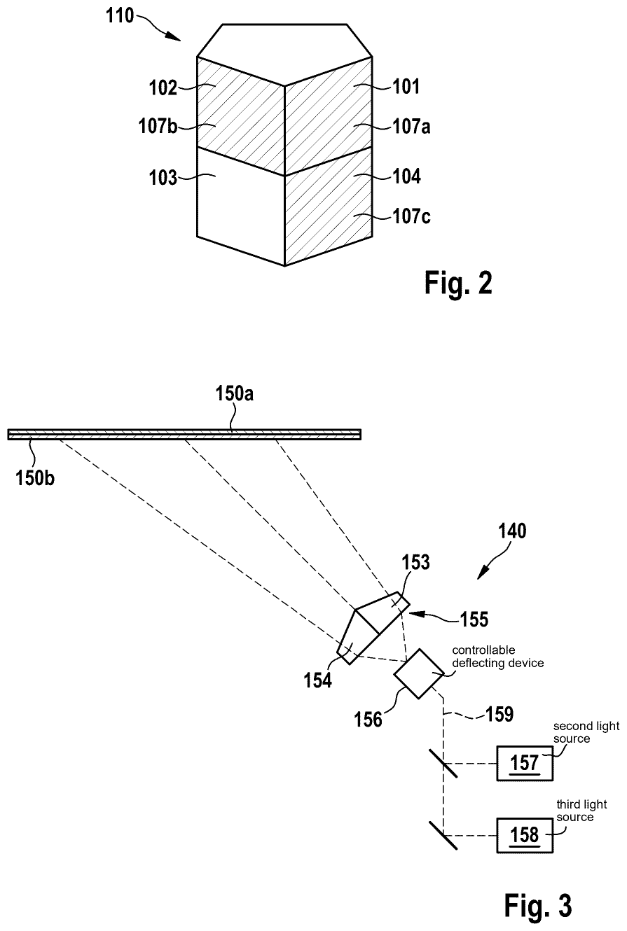

FIG. 2 schematically shows an optical segmentation element 110 for use in an optical system for a virtual retinal scan display as shown as an example in FIG. 1. The optical segmentation element 110 is configured as an optical segmentation lens and comprises a first segment 101, a second segment 102, a third segment 103 and a fourth segment 104. Each of the four segments 101, 102, 103 and 104 is used to project an image content generated by means of a scanning projector unit onto at least one projection region of the diverting unit via an imaging path assigned to a respective segment. In this embodiment, the first 101, second 102 and third segment 103 are covered with a covering 107a to 107c that reflects light beams in an infrared wavelength range. The covering 107a to 107c in this embodiment example is configured as a coating of BK7. The covering 107a to 107c serves in particular to reflect light beams in a wavelength range between 800 nm and 1550 nm.

FIG. 3 schematically shows a second embodiment of an optical system 140 for a virtual retinal scan display. In this embodiment, the projection unit not shown here comprises a second light source 157 for generating a second light beam in a first infrared wavelength range and a third light source 158 for generating a third light beam in a second infrared wavelength range. The first infrared wavelength range and the second infrared wavelength range differ from one another. The controllable deflecting device 156 scans the first and second light beams, which are combined here to form a common light beam 159, onto an optical segmentation element 155. The optical segmentation element 155 is shown in section and comprises two segments 153 and 154 which are free of a covering that reflects or absorbs light beams in an infrared wavelength range. In this embodiment, the optical segmentation element 155 moreover comprises two further segments not shown here. All of the segments 153 and 154 are used to project image content generated by the projector unit onto the diverting unit 150a and 150b via different imaging paths. The diverting unit 150a and 150b is then made of a second 150a and third holographic optical element 150b. The second holographic optical element 150a serves to divert the second light beams onto the eye of the user not shown here, and the third holographic optical element 150b serves to divert the third light beams onto the eye of the user. In this embodiment, the second light source 157 is configured as a first laser feedback interferometer and the third light source 158 is configured as a second laser feedback interferometer. A computing unit not shown here is configured to generate a first image of the first eye region with the pupil of the user from the acquired modulation of the power of the second light source 157 and a second image of the first eye region with the pupil of the user from the acquired modulation of the power of the third light source 158. In both cases, the first and second image depict the same eye region of the user but taken from different perspectives. This can in particular be used to ascertain the gaze vector of the user.

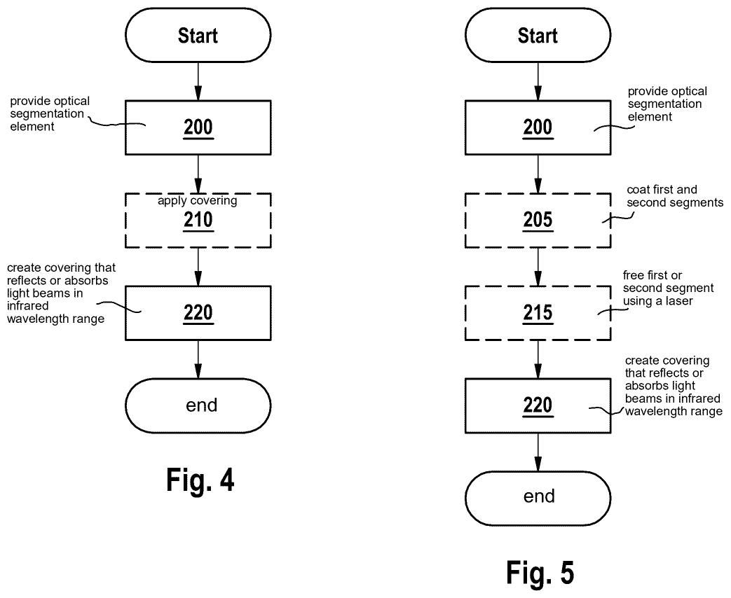

FIG. 4 shows a first embodiment of a method for producing an optical segmentation element in the form of a flowchart. In a method step 200, an optical segmentation element with at least one first and a second segment is provided. The optical segmentation element serves in particular to be used in an optical system for a virtual retinal scan display. In a further method step 220, a covering that reflects or absorbs light beams in an infrared wavelength range is created on the first or second segment, in particular an outer surface of the first or second segment, of the optical segmentation element. In this case, the covering is applied to the first or second segment in an optional method step 210, in particular as a coating by means of powder coating, spraying or painting. The method is then terminated.

FIG. 5 shows a second embodiment of a method for producing an optical segmentation element in the form of a flowchart. In contrast to the first embodiment, the first and second segments are coated completely first in a method step 205 following the method step 200, and the first or second segment is then freed in a subsequent method step 215 using a laser.

1-14. (canceled)

15. An optical segmentation element for use in an optical system for a virtual retinal scan display, the optical segmentation element comprising:
a first segment configured to project an image content generated using a scanning projector unit of the optical system, via a first imaging path onto at least one projection region of a diverting unit of the optical system; and
a second segment configured to project the image content generated using the scanning projector unit via a second imaging path that is different from the first imaging path onto the at least one projection region of the diverting unit;
wherein the first segment of the optical segment element or the second segment of the optical segmentation element are covered at least partly with a covering that reflects or absorbs light beams in an infrared wavelength range.

16. The optical segmentation element according to claim 15, wherein the optical segmentation element additionally comprises:
a third segment configured to project the image content generated using the scanning projector unit via a third imaging path that is different from the first imaging path and the second imaging path onto the at least one projection region of the diverting unit; and
a fourth segment configured to project the image content generated using the scanning projector unit via a fourth imaging path that is different from the first imaging path, the second imaging path, and the third imaging path, onto the at least one projection region of the diverting unit.

17. The optical segmentation element according to claim 16, wherein at least three segments of the first, second, third, and fourth segments are covered, at least partly with the covering that reflects or absorbs light beams in the infrared wavelength range.

18. The optical segmentation element according to claim 16, wherein exactly two segments of the first, second, third, and fourth segments are covered, at least partly with the covering that reflects or absorbs light beams in the infrared wavelength range.

19. The optical segmentation element according to claim 15, wherein the optical segmentation element is configured as an optical segmentation lens.

20. The optical segmentation element according to claim 15, wherein the reflective or absorbent covering is configured to reflect or absorb light beams in a wavelength range between 800 nm and 1550 nm.

21. The optical segmentation element according to claim 15, wherein the reflective or absorbent covering is a coating or a foil or a film.

22. The optical segmentation element according to claim 15, wherein the covering is made of BK7 or silicon or germanium.

23. An optical system for a virtual retinal scan display, comprising:
an image source which provides image content in the form of image data;
an image processing device for the image data;
an optical segmentation element including:
a first segment configured to project the image content generated using a projector unit of the optical system, via a first imaging path onto at least one projection region of a diverting unit of the optical system; and
a second segment configured to project the image content generated using the projector unit via a second imaging path that is different from the first imaging path onto the at least one projection region of the diverting unit;
wherein the first segment of the optical segment element or the second segment of the optical segmentation element are covered at least partly with a covering that reflects or absorbs light beams in an infrared wavelength range;
the projector unit including a time-modulatable first light source configured to generate at least one first light beam, and including a controllable deflecting device for the at least one first light beam for scanning projection of the image content onto the optical segmentation element, and including a second light source configured to generate at least one second light beam in an infrared wavelength range, wherein the controllable deflecting device is configured to scanningly deflect the at least one second light beam onto the optical segmentation element;
the diverting unit onto which the image content from the optical segmentation element can be projected and which is configured to direct the projected image content onto an eye of a user, wherein the diverting unit is configured to scanningly direct the second light beam arriving from the optical segmentation element via the first or second imaging path onto the eye of the user; and
a first sensor configured to acquire second light beams backscattered by a pupil of the user or a modulation of a power of the second light source.

24. The optical system according to claim 23, wherein the projector unit is configured to combine the first and second light beam to a common light beam.

25. The optical system according to 23, wherein the first sensor is: a part of a laser feedback interferometer integrated into the projector unit, or an external first photodetector.

26. The optical system according to claim 23, wherein the optical system further comprises:
a computing unit configured to create a first image of a first eye region with the pupil of the user from the acquired backscattered second light beams or from the acquired modulation of the power of the second light source.

27. The optical system according to claim 26, wherein the optical segmentation element includes four segments for projecting the image content via four different imaging paths onto at least one projection region of the diverting unit of the optical system, wherein one segment of the four segments is respectively assigned to an imaging path, wherein exactly two segments of the four segments, are covered at least partly with the covering that reflects or absorbs light beams in an infrared wavelength range, wherein the optical segmentation element is configured to divert the second light beams in the two segments which are free of the reflective or absorbent covering along the respective imaging path onto the projection region of the diverting unit, wherein the diverting unit is configured to scanningly direct the second light beams onto the eye of the user, wherein the computing unit is configured to create a second image of a first eye region with the pupil of the user from the acquired backscattered second light beams or the acquired modulation of the power of the second light source.

28. A method for producing an optical segmentation, comprising the following method steps:
providing an optical segmentation element for use in an optical system for a virtual retinal scan display, the optical segmentation element including at least a first segment and a second segment; and
producing a covering that reflects or absorbs light beams in an infrared wavelength range on the first segment or the second segment of the optical segmentation element.
